(19) United States
(12) Patent Application Publication
(10) Pub. No.: US 2024/0270529 A1
(43) Pub. Date: Aug. 15, 2024

(54) APPARATUS AND METHOD FOR DISPENSING A CUSHIONING WRAP MATERIAL

(71) Applicant: Ranpak Corp., Concord Township, OH (US)

(72) Inventors: Fredrik Cornelis STAM, Veldhoven (NL); Bram SCHWACHÖFER, Geleen (NL)

(73) Assignee: Ranpak Corp., Concord Township, OH (US)

(21) Appl. No.: 18/566,035

(22) PCT Filed: May 18, 2022
(86) PCT No.: PCT/US2022/029881

§ 371 Date: Nov. 30, 2023

Related U.S. Application Data
(60) Provisional application No. 63/196,291, filed on Jun. 3, 2021.

(51) Int. Cl. B65H 23/08; B31D 1/00; B31D 5/00

(52) U.S. Cl. CPC B65H 23/08; B31D 1/0031; B31D 5/0065; B31D 2205/0023; B31D 2205/007; B65H 2701/1842

(57) ABSTRACT

A dunnage conversion apparatus for dispensing a cushioning wrap material from a roll of expandable slit sheet material is described. The roll of expandable slit sheet material includes an expandable slit sheet material in an unexpanded state. The expandable slit sheet material is pulled from the roll of expandable slit sheet material and expanded to a pre-expanded state and an expanded state. To expand the expandable slit sheet material and form the cushioning wrap material, a stretching force is applied to the expandable slit sheet material in a stretching direction as it is pulled from the roll of expandable slit sheet material. Accordingly, the dunnage conversion apparatus includes a tensioning device for assisting in the application of such stretching force.

### FIELD OF THE INVENTION

The present invention relates generally to the field of packing materials and, more particularly, to packaging materials for wrapping and cushioning articles.

### BACKGROUND

In the process of packing an article in a packaging container for shipping or transporting the article from one location to another, a protective packaging material (dunnage product) is typically placed in the packaging container with the article. The dunnage product is included to fill any voids or to cushion the article during the shipping or transportation process. Paper packing material is an ecologically-friendly packing material that is recyclable, biodegradable, and composed of a renewable resource. While paper in sheet form could possibly be used as a protective packaging material, it may be preferable to convert the sheets of paper into a low-density dunnage product.

For example, expandable slit-sheet packing material, also referred to as slit-sheet material, slit-sheet stock material, die-cut sheet stock material, or slit material, is useful as a cushioning material for wrapping articles and as a void-fill material for packages. The slit-sheet stock material has a plurality of slits generally arrayed in parallel rows across a width dimension of the slit-sheet stock material. When a stretching force is applied to this slit-sheet material in a length or longitudinal direction, the slit-sheet material expands in both length and thickness, while decreasing in width, to yield an increase in volume and comparable decrease in density. As used herein, the term expanding, therefore refers to a three-dimensional expansion or a volume expansion. Such slit-sheet paper packing material, and the manufacturing thereof, are described in greater detail in U.S. Pat. Nos. 5,667,871 and 5,688,578, the disclosures of which are hereby incorporated herein by reference in their entireties.

### SUMMARY

The present disclosure describes a dunnage conversion apparatus for dispensing a cushioning wrap material from a roll of expandable slit sheet material. The roll of expandable slit sheet material includes an expandable slit sheet material in an unexpanded state. The expandable slit sheet material can be pulled from the roll of expandable slit sheet material and expanded to a pre-expanded state and an expanded state. To expand the expandable slit sheet material and form the cushioning wrap material, a stretching force is applied to the expandable slit sheet material in a stretching direction as it is pulled from the roll of expandable slit sheet material. The stretching force is applied to the expandable slit sheet material by the user, in combination with a tensioning device in the dunnage conversion apparatus.

An exemplary roll of expandable slit sheet material includes an expandable slit sheet material in an unexpanded state. The expandable slit sheet material includes a plurality of rows of slits extending across a width of the expandable slit sheet material such that a force applied across the direction of each slit causes the slit to open.

An exemplary dunnage conversion apparatus for dispensing a cushioning wrap material from a roll of expandable slit sheet material includes a frame. The frame has a supply support for supporting the roll of expandable slit sheet material for rotation about a central axis as the expandable slit sheet material is pulled from the roll. The apparatus also includes a tensioning device having a friction member abutting the roll of expandable slit sheet material and at least one force spring secured to the frame and the friction member. The force spring is configured to bias the friction member toward the roll of expandable slit sheet material in a direction perpendicular to the central axis. The force spring and friction member maintain consistent pressure on the roll as the expandable slit sheet material is pulled away from the roll and as the roll decreases in diameter. The force applied by the tensioning mechanism against the roll of expandable slit sheet material constantly and automatically applies a rotational resistance to the roll as the roll decreases in diameter. The force withdrawing the expandable slit sheet material from the roll cooperates with the rotational resistance to expand the expandable slit sheet material from the unexpanded state to an expanded state to form the cushioning wrap material.

The friction member may extend across at least a partial length of the roll of expandable slit sheet material in a direction parallel to the central axis.

The friction member may extend across an entire length or more of the roll of expandable slit sheet material in a direction parallel to the central axis.

The friction member may have friction member supports pivotably mounted to the frame, and a bar member mounted to the friction member supports, the bar member extending parallel to and contacting the roll of expandable slit sheet material.

The at least one force spring may be secured to the frame at a first end thereof and secured to the friction member at a second end thereof.

The at least one force spring may be a constant force spring.

The at least one force spring may be configured to bias the friction member against the roll of expandable slit sheet material such that the bar member constantly abuts the roll of expandable slit sheet material as the roll of expandable slit sheet material decreases in diameter.

The dunnage conversion apparatus may additionally include a pair of powered gripping rollers configured to engage the expandable slit sheet material and pull the expandable slit sheet material from the roll of expandable slit sheet material.

The pair of powered gripping rollers may be mounted downstream of the roll of expandable slit sheet material and the tensioning device.

The pair of powered gripping rollers may be biased toward one another and are configured to receive the expandable slit sheet material therebetween.

The dunnage conversion apparatus may additionally include a cutting device for cutting the cushioning wrap material after a desired length of expandable slit sheet material has been pulled away from the roll of expandable slit sheet material and a desired length of cushioning wrap material has been formed.

The cutting device may be mounted downstream of the roll of expandable slit sheet material, the tensioning device, and the pair of powered rollers.

Another exemplary dunnage conversion apparatus for dispensing a cushioning wrap material from a roll of expandable slit sheet material also includes a frame. The frame has a supply support for supporting the roll of expandable slit sheet material for rotation about a central axis as the expandable slit sheet material is pulled from the roll of expandable slit sheet material. The dunnage conversion apparatus also includes a tensioning device that includes a plurality of pre-expansion rollers extending parallel to and spaced apart from the central axis. The plurality of pre-expansion rollers define a serpentine path through which the expandable slit sheet material passes as the expandable slit sheet material is pulled from the roll of expandable slit sheet material. The force withdrawing the expandable slit sheet material from the roll cooperates with the plurality of pre-expansion rollers to cause the expandable slit sheet material to expand from the unexpanded state to a pre-expanded state as the expandable slit sheet material passes through the serpentine path, thereby reducing an amount of stretching force required to cause the expandable slit sheet material to expand to the expanded state to form the cushioning wrap material.

The plurality of pre-expansion rollers may include three pre-expansion rollers forming the serpentine path.

The dunnage conversion apparatus may include a pair of powered gripping rollers configured to engage the expandable slit sheet material and pull the expandable slit sheet material from the roll of expandable slit sheet material.

The pair of powered gripping rollers may be mounted downstream of the roll of expandable slit sheet material and the plurality of pre-expansion rollers.

The pair of powered gripping rollers may be biased toward one another and are configured to receive the expandable slit sheet material therebetween.

The dunnage conversion apparatus may further include a cutting device for cutting the cushioning wrap material after a desired length of expandable slit sheet material has been pulled away from the roll of expandable slit sheet material and a desired length of cushioning wrap material has been formed.

The cutting device may be mounted downstream of the roll of expandable slit sheet material, the plurality of pre-expansion rollers, and the pair of powered rollers.

A method of dispensing a cushioning wrap material from a dunnage conversion apparatus includes the following steps: (a) pulling the expandable slit sheet material away from the roll of expandable slit sheet material, which causes the roll of expandable slit sheet material to rotate about the central axis and decrease in diameter; (b) applying a rotational resistance to the roll of expandable slit sheet material with a tensioning device to cause the expandable slit sheet material to expand in length and thickness during the pulling step. The tensioning device includes a friction member abutting the roll of expandable slit sheet material, and at least one force spring secured to the frame and the friction member. The step of applying a rotational resistance to the roll of expandable slit sheet material includes biasing the friction member of the tensioning device toward the roll of expandable slit sheet material in a direction perpendicular to the central axis with the force spring during the pulling step.

Another method of dispensing a cushioning wrap material from a dunnage conversion apparatus includes the following steps: (a) pulling the expandable slit sheet material from the roll of expandable slit sheet material and between a plurality of pre-expansion rollers extending parallel to and spaced apart from the central axis that define a serpentine path through which the expandable slit sheet material is pulled; and (b) expanding the expandable slit sheet material from the unexpanded state to a pre-expanded state as the expandable slit sheet material is pulled through the serpentine path formed by the plurality of pre-expansion rollers.

Another exemplary dunnage conversion apparatus for dispensing a cushioning wrap material from a supply of expandable slit sheet material includes a supply support for the supply of expandable slit sheet material. The expandable slit sheet material on the supply is in an unexpanded state. The dunnage conversion apparatus also includes a tensioning device that facilitates application of constant tension to the expandable slit sheet material as the expandable slit sheet material is drawn from the supply. The constant tension causes the expandable slit sheet material to expand from the unexpanded state to an expanded state for form the cushioning wrap material.

### BRIEF DESCRIPTION OF THE DRAWINGS

FIG. 1 is a schematic view of an exemplary dunnage conversion apparatus having a tensioning device.

FIG. 2 is a perspective view of an expandable slit sheet material in an unexpanded state.

FIG. 3A is a perspective view of the expandable slit sheet material in an expanded state.

FIG. 3B is a schematic representation of a slit of the expandable slit sheet material in the expanded state.

FIG. 4A is a perspective view of the expandable slit sheet material in a pre-expanded state.

FIG. 4B is a schematic representation of a slit of the expandable slit sheet material in the pre-expanded state.

FIG. 5 is a perspective view of the exemplary dunnage conversion apparatus having a first exemplary embodiment of the tensioning device for applying a rotational resistance to a roll of expandable slit sheet material.

FIGS. 6A and 6B are cross-sectional views of the exemplary dunnage conversion apparatus of FIG. 5.

FIG. 7A is a perspective view of the exemplary dunnage conversion apparatus having a second exemplary embodiment of the tensioning device for applying resistance to the expandable slit sheet material being pulled from the roll of expandable slit sheet material.

FIG. 7B is an enlarged perspective view of a portion of the second exemplary embodiment of the tensioning device of FIG. 7A.

FIG. 8 is a perspective view of the expandable slit sheet material passing over one of a plurality of pre-expansion rollers of the second exemplary embodiment of the tensioning device of FIGS. 7A and 7B.

FIG. 9 is a side view of the plurality of pre-expansion rollers of the second exemplary embodiment of the tensioning device of FIGS. 7A and 7B.

FIG. 10A is a diagram illustrating the stretching force required to expand the expandable slit sheet material from an unexpanded state to an expanded state.

FIG. 10B is a diagram illustrating the reduced stretching force required to expand the expandable slit sheet material from a pre-expanded state to the expanded state.

FIG. 11 is a schematic view of another exemplary dunnage conversion apparatus having the tensioning device.

### DETAILED DESCRIPTION

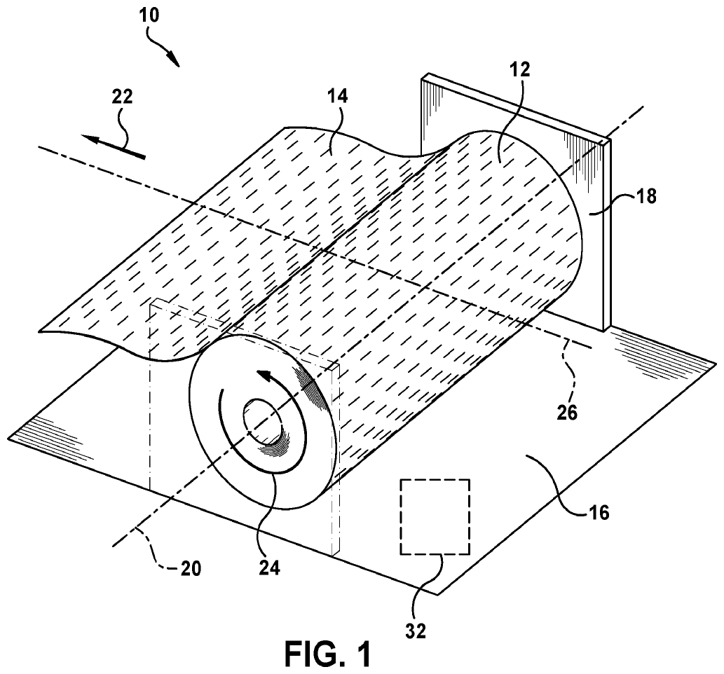

Turning now to the drawings, and initially to FIG. 1, FIG. 1 shows a schematic dunnage conversion apparatus 10 for dispensing a cushioning wrap material from a supply, for example a roll 12, of expandable slit sheet material. The roll 12 of expandable slit sheet material includes an expandable slit sheet material 14 in an unexpanded state. The dunnage conversion apparatus 10 includes a frame 16 having at least one supply support 18, or a pair of laterally-spaced supply supports 18 for supporting the supply or roll 12 of expandable slit sheet material for rotation about a central axis 20. The frame 16 may be enclosed in or defined by a housing (not shown) that encloses portions of the apparatus 10 and also may enclose the roll 12. The expandable slit sheet material 14 can be pulled from the roll 12 of expandable slit sheet material in the direction of the arrow 22 in FIG. 1, causing the roll 12 to rotate about the central axis 20 in the direction of the arrow 24. As the expandable slit sheet material 14 is pulled from the roll 12 and the roll 12 of expandable slit sheet material rotates about the central axis 20, the roll 12 decreases in diameter.

To form the cushioning wrap material, a tensioning or stretching force applied to the expandable slit sheet material 14 in a longitudinal or stretching direction 26, transverse to the central axis 20, causes the expandable slit sheet material 14 to expand as it is pulled from the roll 12. The dunnage conversion apparatus 10, therefore, includes a tensioning device 32 (shown schematically in FIG. 1) for assisting in the application of the stretching force on the expandable slit sheet material 14 as it is pulled from the roll 12. Specifically, the tensioning device 32 may facilitate application of constant tension to the expandable slit sheet material as the expandable slit sheet material is drawn from the supply or roll 12. The constant tension therefore causes the expandable slit sheet material to expand from the unexpanded state to an expanded state to form the cushioning wrap material.

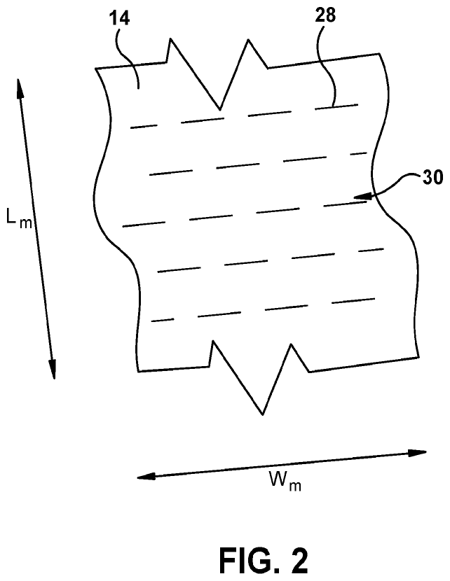

With reference to FIGS. 2-4B, an exemplary expandable slit sheet material 14 is depicted in various states of expansion. Specifically, FIG. 2 shows the expandable slit sheet material 14 in the unexpanded state, as it is provided on the roll 12 of expandable slit sheet material. The expandable slit sheet material 14 has a plurality of slits 28 arranged in a plurality of longitudinally spaced (i.e., along a length Lm of the expandable slit sheet material 14), laterally extending (i.e., along a width Wm of the expandable slit sheet material 14) rows 30 of slits 28. Different arrangements of slits 28 may include any one or more of different arrangements of rows 30 relative to one another, differently sized slits 28, different spacing between slits 28, different slit shape or slit positioning, such as angular positioning, relative to adjacent slits 28, etc. The slits 28 may be formed by perforating, such as by cutting, or otherwise weakening the expandable slit sheet material 14 intermittently across the width Wm of the expandable slit sheet material 14.

The rows 30 of slits 28 generally are parallel to one another and generally are periodically, and typically equally, longitudinally spaced from one another. The slits 28 are intermittently but periodically dispersed across the rows 30, with the slits 28 of each row 30 generally being staggered (i.e., laterally offset) in relation to slits 28 of adjacent rows 30. Across each row 30 of slits 28, there may be a greater length of combined slit regions than a combined length of un-slit regions disposed between each slit 28, providing for an optimum amount of expansion of the expandable slit sheet material 14. The expandable slit sheet material 14 is configured to expand in one or more dimensions. In other words, when a stretching force is applied to the expandable slit sheet material 14 in the stretching direction (i.e., along the length Lm of the expandable slit sheet material 14) across the widthwise-extending slits 28, a volumetric expansion of the expandable slit sheet material 14 occurs.

An exemplary expandable slit sheet material 14 includes paper, such as kraft paper, and typically includes single-ply kraft paper. A suitable kraft paper may have various basis weights, such as twenty-pound or forty-pound, for example. The expandable slit sheet material 14 may have any of many alternative arrangements of slits 28 or differing sheet thicknesses (i.e., a dimension perpendicular to the face of the paper in the perspective shown in FIG. 2, typically measured by or related to basis weight).

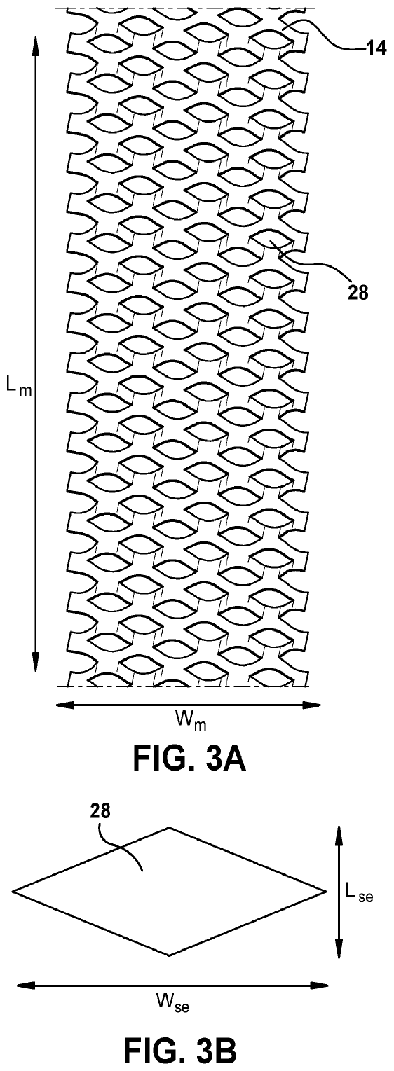

Upon application of the stretching force, the expandable slit sheet material 14 expands from the unexpanded state to the expanded state to form the cushioning wrap material. FIG. 3A shows the expandable slit sheet material 14 in the expanded state upon application of such stretching force in the stretching direction (i.e., along the length Lm of the expandable slit sheet material 14). Upon application of the stretching force, the length Lm of the expandable slit sheet material 14 increases, while the width Wm decreases, compared to the expandable slit sheet material 14 in the unexpanded state (FIG. 2). Specifically, when the stretching force is applied to the expandable slit sheet material 14 in the stretching direction, regions of the expandable slit sheet material 14 on either side of the slits 28 in the stretching direction are pulled apart from each other and the slits 28 are opened to a shape having an expanded-state length Lₛₑ and an expanded-state width Wₛₑ, as illustrated in FIG. 3B.

When the stretching force is applied to the expandable slit sheet material 14 in the stretching direction, portions of the expandable slit sheet material 14 between the slits 28 also rotate relative to the previously linear plane of the expandable slit sheet material 14 in the unexpanded state (FIG. 2). This causes the thickness of the expandable slit sheet material 14 also to increase, as the rotated regions of the expandable slit sheet material 14 extend, or protrude, beyond the plane of the expandable slit sheet material in its unexpanded state. The thickness of the expandable slit sheet material 14 in the expanded state (FIG. 3A) is therefore greater than the thickness of the expandable slit sheet material 14 in the unexpanded state (FIG. 2) by an order of magnitude, or more, when stretched in this manner.

Additionally, as the stretching force is applied to the expandable slit sheet material 14 in the stretching direction and the expandable slit sheet material 14 is expanded to the expanded state (FIG. 3A), the expandable slit sheet material 14 inelastically deforms. This inelastic deformation causes the expandable slit sheet material 14 to remain in an expanded state and decreases the tendency of the expandable slit sheet material 14 to return to its previous unexpanded state (FIG. 2). In other words, the stretching force applied is sufficient to expand the expandable slit sheet material 14 past its elastic limit.

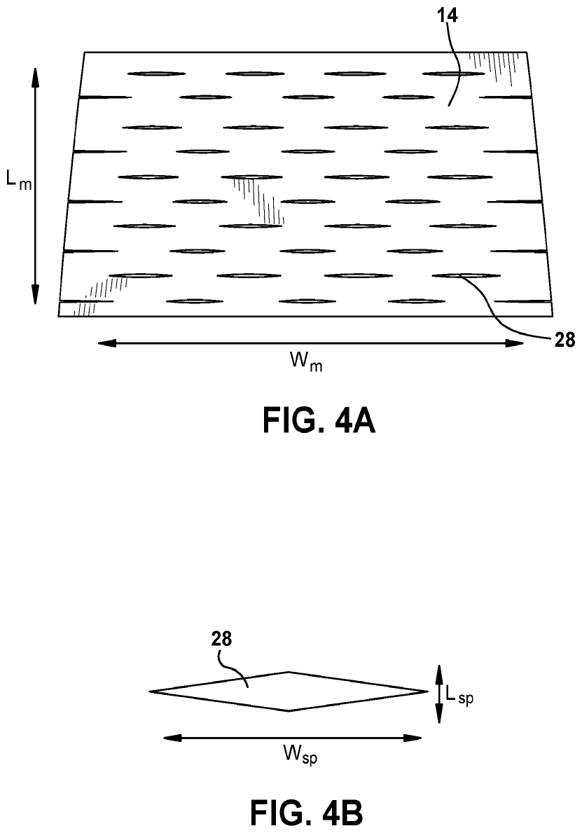

In one exemplary embodiment of the tensioning device 32 of the dunnage conversion apparatus 10, described in more detail below, the tensioning device 32 is configured to assist in application of the stretching force such that the expandable slit sheet material 14 is first pre-expanded to a pre-expanded state before being expanded to the expanded state. FIG. 4A shows the expandable slit sheet material 14 in the pre-expanded state. In the pre-expanded state, regions of the expandable slit sheet material 14 on either side of the slits 28 in the stretching direction are pulled apart from each other, albeit less so than in the expanded state 28 (FIG. 3A), such that the slits 28 are opened slightly (i.e., less than the slits 28 are opened in the expanded state depicted in FIG. 3A). In other words, the slits 28 in the pre-expanded state (FIG. 4A) are opened partially to a shape having a partially-expanded-state length Lₛₚ that is less than the expanded-state length Lₛₑ of the slits 28 in the expanded state, and a partially-expanded-state width Wₛₚ that is greater than the expanded-state width Wₛₑ of the slits 28 in the expanded state.

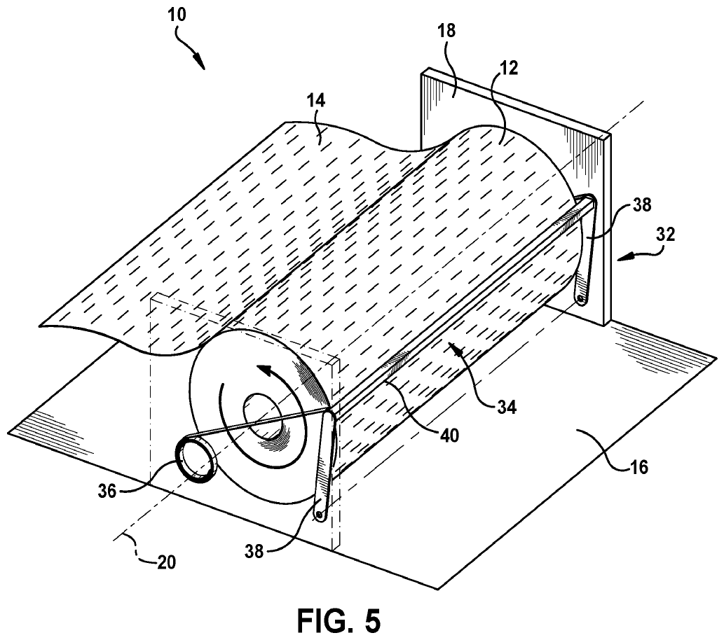

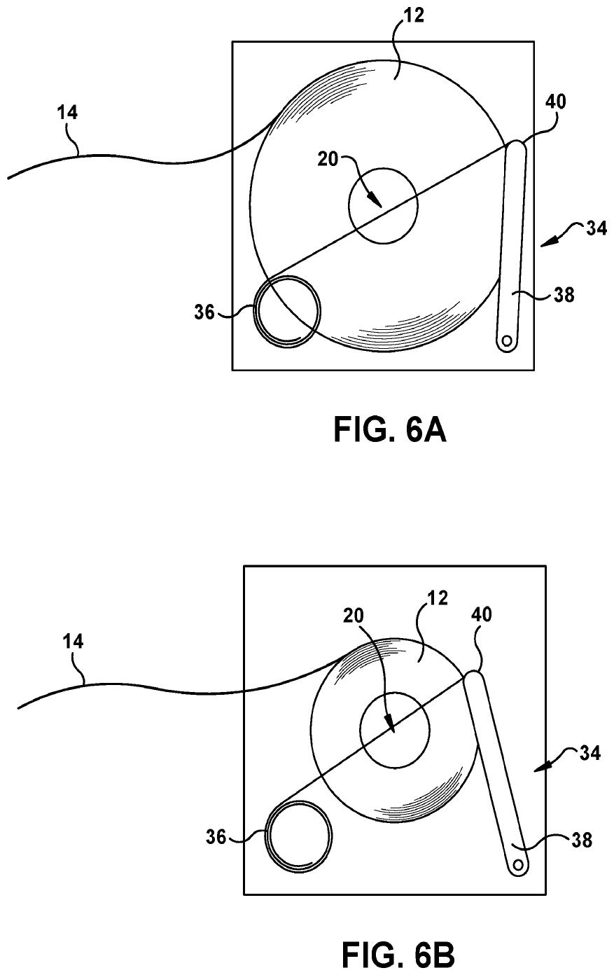

Now turning to FIGS. 5-6B, a first exemplary embodiment of the tensioning device 32 in the dunnage conversion machine 10 will be described. The first exemplary embodiment of the tensioning device 32 creates resistance on rotation of the roll 12 of expandable slit sheet material as the expandable slit sheet material 14 is pulled therefrom and as the roll 12 of expandable slit sheet material rotates around the central axis 20. The first exemplary embodiment of the tensioning device 32 includes a friction member 34 abutting the roll 12 of expandable slit sheet material and at least one force spring 36 secured between the frame 16 and the friction member 34. The force spring 36 may be a constant force spring that applies a constant force over the entire range of movement of the friction member 34 against the roll 12. The force spring 36 is configured to bias the friction member 34 against the roll 12 in a direction perpendicular to the central axis 20 as the expandable slit sheet material 14 is pulled away from the roll 12.

The friction member 34 extends at least partially across an entire length of the roll 12 of expandable slit sheet material in a direction parallel to the central axis 20. For example, as depicted in FIG. 5, the friction member 34 extends across an entire length or more of the roll 12 of expandable slit sheet material in a direction parallel to the central axis 20 so that the friction member 34 abuts the roll 12 along the entire length thereof. The friction member 34 may include at least one friction member support 38 pivotably mounted to the frame 16, and a bar member 40 extending between or otherwise mounted to the at least one friction member support 38. The friction member supports 38 may be pivotably mounted to the frame 16 at respective first ends thereof and mounted to the bar member 40 at respective second ends thereof.

As depicted in FIG. 5, two friction member supports 38 are mounted at or beyond respective ends of the roll 12 of expandable slit sheet material and the bar member 40 extends fully therebetween. As depicted, therefore, the bar member 40 is configured to abut the roll 12 along the entire length thereof. Alternatively, the bar member 40 may be configured to extend only partially between the friction member supports 38. For example, the bar member 40 may be mounted between the friction member supports 38 such that the bar member 40 is configured to extend parallel to and contact the roll 12 of expandable slit sheet material along only a partial length of the roll 12. In another alternative example, a single friction member support 38 may be mounted to the frame 16 at or beyond a respective end of the roll 12 of expandable slit sheet material or at a position between the respective ends of the roll 12. The single friction member support 38 may be mounted to the frame 16 at the first end thereof and mounted to the bar member 40 at the second end thereof.

The force spring 36 is secured to the frame 16 at a first end thereof and is secured to the at least one friction member 34 at a second end thereof. For example, the second end of the force spring 36 may be secured to the second end of at least one of the friction member supports 38 or to the bar member 40. The force spring 36 may be manually adjustable to provide various biasing forces on the friction member 34. The force spring 36 may be a constant force spring. The force spring 36, therefore, is configured to bias the friction member 34, specifically the bar member 40, against the roll 12 of expandable slit sheet material with a constant force as the expandable slit sheet material 14 is pulled from the roll 12 and the roll 12 rotates around the central axis 20 and decreases in diameter, as illustrated in FIGS. 6A and 6B. The first exemplary embodiment of the tensioning device 32 therefore is configured to constantly and automatically apply a rotational resistance on the roll 12 as the roll 12 decreases in diameter.

The force spring 36 may apply a constant force against the roll 12 in the range of 30 Newtons to 40 Newtons, such as for example 35 Newtons. The rotational resistance on the roll 12, caused by the force applied by the force spring 36, in combination with a friction coefficient of the bar member 40 and the roll 12 (based on their respective roughness) will determine the force required to pull the expandable slit sheet material 14 from the roll 12. Generally, the combination of the friction coefficient of the bar member 40 and the roll 12, and the rotational resistance of the roll 12 are sufficient to cause the expandable slit sheet material 14 to expand from the unexpanded state (FIG. 2) to the expanded state (FIG. 3A) as the expandable slit sheet material 14 is pulled from the roll 12 and expanded to form the cushioning wrap material.

A method of dispensing the cushioning wrap material from the dunnage conversion apparatus described herein, having the first exemplary tensioning device, includes a step of pulling the expandable slit sheet material away from the roll of expandable slit sheet material. The step of pulling the expandable slit sheet material away from the roll of expandable slit sheet material causes the roll of expandable slit sheet material to rotate about the central axis and decrease in diameter. The method additionally includes applying a rotational resistance on rotation of the roll of expandable slit sheet material with the tensioning device as the roll of expandable slit sheet material decreases in diameter to cause the expandable slit sheet material to expand in length and thickness during the pulling step. Various exemplary tensioning devices are described herein, and include a friction member abutting the roll of expandable slit sheet material and at least one force spring secured to the frame and the friction member, which can apply force constantly and automatically without any initiating action by the user. The step of applying a rotational resistance on rotation of the roll of expandable slit sheet material therefore includes biasing the friction member of the tensioning device toward the roll of expandable slit sheet material in a direction perpendicular to the central axis with the force spring during the step of pulling the expandable slit sheet material and as the roll of expandable slit sheet material decreases in diameter.

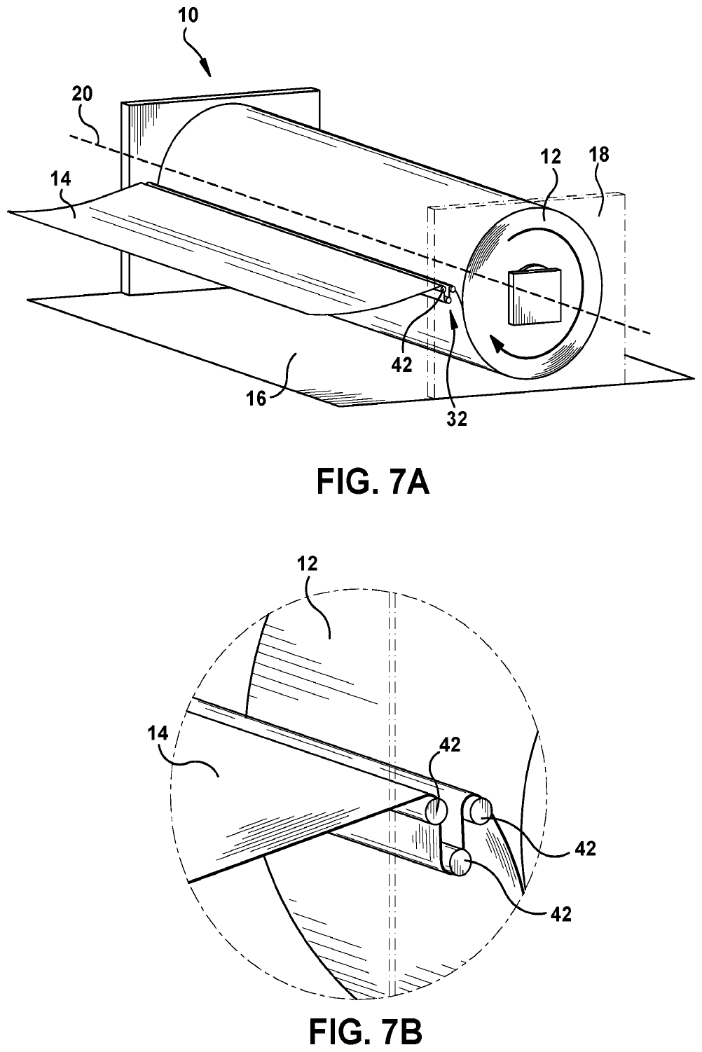

With reference to FIGS. 7A-9, a second exemplary embodiment of the tensioning device 32 is depicted. The second exemplary embodiment of the tensioning device 32 includes a plurality of pre-expansion rollers 42 to create resistance on the expandable slit sheet material 14 as it is being pulled from the roll 12 of expandable slit sheet material. The plurality of pre-expansion rollers 42 each extend parallel to and are spaced apart from the central axis 20 and the roll 12 of expandable slit sheet material. The plurality of pre-expansion rollers 42 are mounted downstream (the direction in which the expandable slit sheet material 14 is pulled) of the roll 12. As illustrated in FIG. 7B, the plurality of pre-expansion rollers 42 define a serpentine path through which the expandable slit sheet material 14 passes as the expandable slit sheet material 14 is pulled from the roll 12. In the depicted embodiment, three pre-expansion rollers 42 form the serpentine path, however two pre-expansion rollers 42, or more than three pre-expansion rollers 42, may be configured to similarly form the serpentine path. The plurality of pre-expansion rollers 42 cause the expandable slit sheet material 14 to expand from the unexpanded state (FIG. 2) to the pre-expanded state (FIG. 4A) as the expandable slit sheet material 14 is pulled from the roll 12 and through the serpentine path and then to the fully expanded state (FIG. 3A).

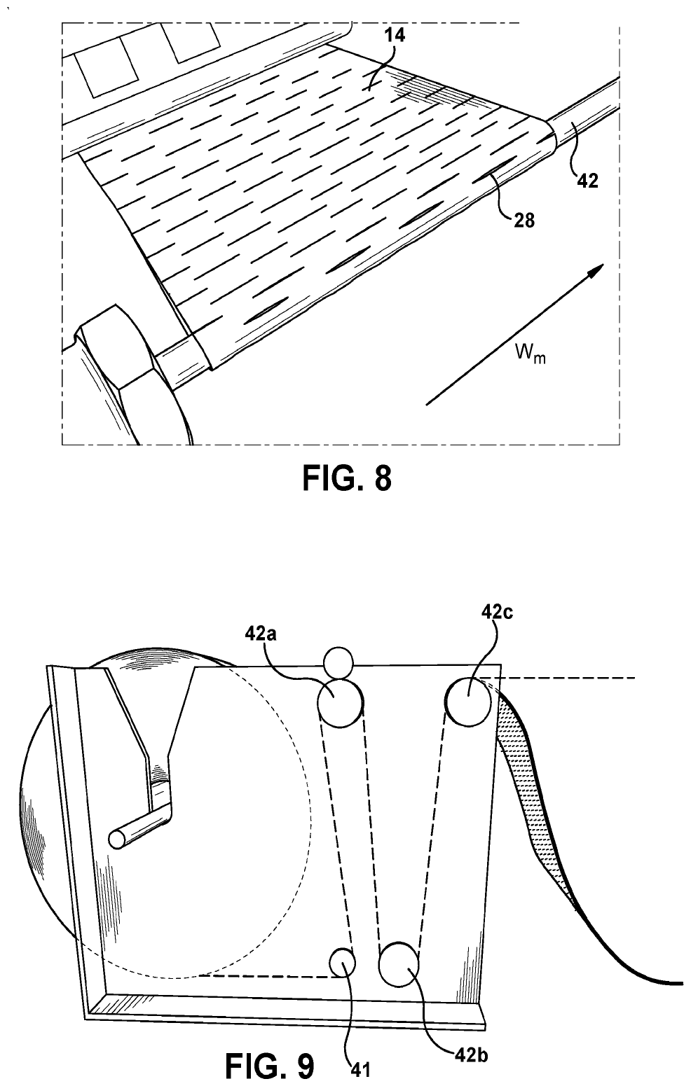

Specifically, with reference to FIG. 8, as the expandable slit sheet material 14 travels through the serpentine path formed by the plurality of pre-expansion rollers 42, the expandable slit sheet material 14 is forced to bend or fold over and partially around each of the plurality of pre-expansion rollers 42 along the width Wm of the expandable slit sheet material 14. Each of the plurality of pre-expansion rollers 42 has a small diameter relative to the spacing between the rows of slits, and that tight radius defines a sharp bend over which the expandable slit sheet material 14 travels around each of the pre-expansion rollers 42. As the expandable slit sheet material 14 bends or folds over each of the plurality of pre-expansion rollers 42, regions of the expandable slit sheet material 14 on either side of the slits 28 in the stretching direction are pulled apart from each other and the slits 28 are incrementally pulled opened, as described above with reference to FIGS. 4A and 4B. That is, the bending of the expandable slit sheet material 14 over each of the plurality of pre-expansion rollers 42 is sufficient to first open the slits 28 slightly and expand the expandable slit sheet material 14 to the pre-expanded state, but not enough to open the slits 28 beyond the elastic state. But as the expandable slit sheet material 14 continues moving through and past the serpentine path, forces on the slits 28 continue to expand the slit sheet material 14 past the elastic state to the expanded state.

With reference to FIG. 9, for example, the plurality of pre-expansion rollers 42 may include three pre-expansion rollers 42a-c. A first pre-expansion roller 42a imparts a relatively small amount of constant friction on the expandable slit sheet material 14 passing thereover. This relatively small amount of constant friction causes the expandable slit sheet material 14 to pass tightly over a second pre-expansion roller 42b as it continues along the serpentine path. The second pre-expansion roller 42b, therefore, slightly opens the slits 28 of the expandable slit sheet material 14 as the expandable slit sheet material 14 is tightly bent over and around the second pre-expansion roller 42b. The second pre-expansion roller 42b is free to rotate and may have a relatively tight radius, as described above. A third pre-expansion roller 42b imparts a further small amount of constant friction on the slightly opened expandable slit sheet material 14 passing thereover to further open the slits 28. The tensioning device 32 may additionally include a guiding roller 41 positioned upstream of the first pre-expansion roller 42a for guiding the expandable slit sheet material 14 from the roll, such that it approaches the first pre-expansion roller 42 at a constant angle even as the roll 12 of expandable slit sheet material decreases in diameter.

A method of dispensing the cushioning wrap material from the dunnage conversion apparatus described herein, having the second exemplary tensioning device, includes a step of pulling the expandable slit sheet material away from the roll of expandable slit sheet material and between a plurality of pre-expansion rollers extending parallel to and spaced apart from the central axis. The plurality of pre-expansion rollers define a serpentine path through which the expandable slit sheet material is pulled. The method additionally includes expanding the expandable slit sheet material from the unexpanded state to a pre-expanded state as the expandable slit sheet material is pulled through the serpentine path formed by the plurality of pre-expansion rollers.

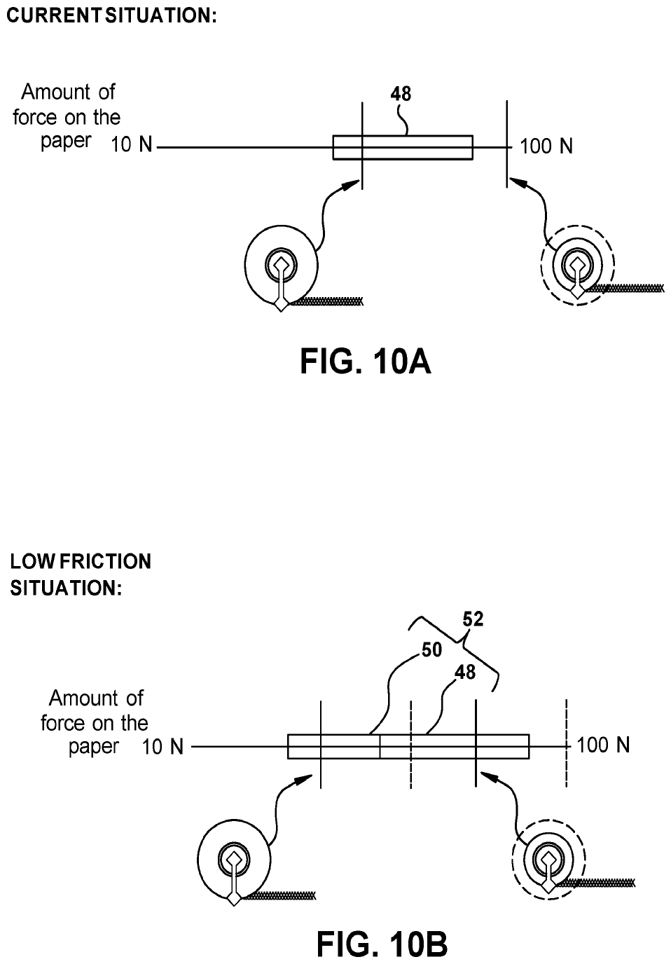

By expanding the expandable slit sheet material 14 to the pre-expanded state (FIG. 4A) with the plurality of pre-expansion rollers 42, the amount of stretching force thereafter required to expand the expandable slit sheet material 14 to the expanded state (FIG. 3A) and form the cushioning wrap material is reduced. FIGS. 10A-B graphically illustrate this force reduction. Specifically, FIG. 10A illustrates a line graph representing the amount of stretching force required to expand the expandable slit sheet material 14 from the unexpanded state (FIG. 2) to the expanded state (FIG. 3A), as done without the plurality of pre-expansion rollers 42. A first region 48 on the line graph represents the range of stretching force required to expand the expandable slit sheet material 14 from the unexpanded state (FIG. 2) to the expanded state (FIG. 3A), without causing the expandable slit sheet material 14 to tear.

In comparison, FIG. 10B illustrates a line graph representing the amount of stretching force required to expand the expandable slit sheet material 14 from the pre-expanded state (FIG. 4A) to the expanded state (FIG. 3A). A second, larger region 52 on the line graph in FIG. 10B represents the range of stretching force required to expand the expandable slit sheet material 14 from the pre-expanded state (FIG. 4A) to the expanded state (FIG. 3A), without causing the expandable slit sheet material 14 to tear. As depicted, the stretching force required to expand the expandable slit sheet material 14 from the pre-expanded state to the expanded state (FIG. 10B) is greatly reduced, having a significantly reduced minimum required stretching force (range 50), than the stretching force required to expand the expandable slit sheet material 14 from the unexpanded state to the expanded state (FIG. 10A).

The tensioning devices 32 of the first embodiment and the second embodiment can be combined in the dunnage conversion apparatus 10 to further enhance the expansion of the expandable slit sheet material 14 to the expanded state to form the cushioning wrap material.

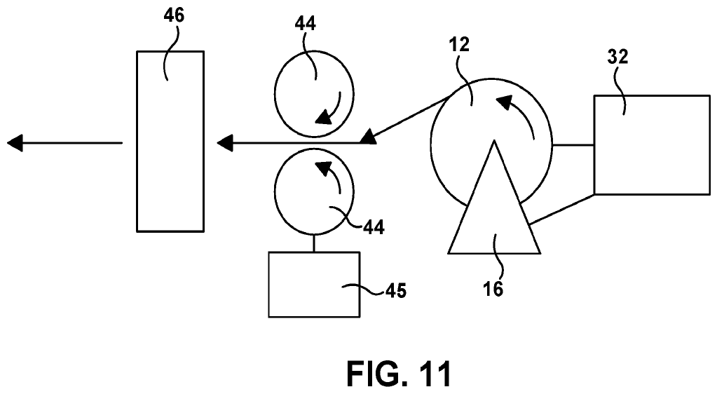

Turning now to FIG. 11, additional features of the dunnage conversion apparatus 10 will be described. For example, in either exemplary embodiment, the dunnage conversion apparatus 10 may additionally include at least one pair of powered gripping rollers 44 configured to engage the expandable slit sheet material 14 and pull the expandable slit sheet material 14 from the roll 12 of expandable slit sheet material. Specifically, the pair of powered gripping rollers may be mounted in the dunnage conversion apparatus 10 and configured to receive the expandable slit sheet material 14 therebetween. The pair of powered gripping rollers 44 may be biased towards one another to provide a constant and equivalent gripping force across the lateral width Wm of the expandable slit sheet material 14 passing therebetween. The pair of powered gripping rollers 44 are configured to grip the expandable slit sheet material 14 and rotate around a rotation axis parallel to the central axis 20 so as to pull the expandable slit sheet material 14 away from the roll 12 of expandable slit sheet material. The pair of powered gripping rollers 44 are mounted downstream (the direction in which the expandable slit sheet material 14 is pulled) of the roll 12 of expandable slit sheet material and the tensioning device 32 of either exemplary embodiment. The pair of powered gripping rollers 44 therefore are configured to apply the stretching force on the expandable slit sheet material 14 and cause the expansion of the expandable slit sheet material from the unexpanded state (in the first example described above) or from the pre-expanded state (in the second example described above) to the expanded state.

The pair of powered rollers 44 may be covered or otherwise formed with a friction material or gripping means sufficient to grip the expandable slit sheet material 14 and pull the expandable slit sheet material 14 away from the roll 12 of expandable slit sheet material, without the expandable slit sheet material 14 slipping therebetween.

The pair of powered gripping rollers 44 may be driven by a motor 45 and the speed of the pair of powered gripping rollers 44 may be set by an appropriate configuration of drive elements, such as gears and chains, or the speed may be set electronically via a controller. The controller may also control the starting and stopping of the pair of powered gripping rollers so as to produce a controlled length of cushioning wrap material. The controller also may be configured to control a cutting device 46. Specifically, in either exemplary embodiment, the dunnage conversion apparatus 10 may additionally include a cutting device 46 for cutting the cushioning wrap material after a desired length of expandable slit sheet material 14 has been pulled away from the roll 12 of expandable slit sheet material, expanded, and a desired length of cushioning wrap material has been formed. The cutting device 46 is mounted in the dunnage conversion apparatus downstream (the direction in which the expandable slit sheet material 14 is pulled) of the pair of powered rollers.

In summary, the disclosure describes a dunnage conversion apparatus 10 for dispensing a cushioning wrap material from a roll 12 of expandable slit sheet material. The roll 12 of expandable slit sheet material includes an expandable slit sheet material 14 in an unexpanded state. The expandable slit sheet material 14 is pulled from the roll 12 of expandable slit sheet material and expanded to an expanded state. To expand the expandable slit sheet material 14 and form the cushioning wrap material, a stretching force is applied to the expandable slit sheet material 14 in a stretching direction as it is pulled from the roll 12. Accordingly, the dunnage conversion apparatus 10 includes a tensioning device 32 for assisting in the application of such stretching force.

Although the invention defined by the following claims has been shown and described with respect to a certain embodiment, equivalent alternations and modifications will occur to others skilled in the art upon reading and understanding this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiments of the invention. In addition, while a particular feature of the invention may have been described above with respect to only one of several illustrated embodiments, such feature may be combined with one or more other features of the other embodiments, as may be desired and advantageous for any given or particular application.

1. A dunnage conversion apparatus for dispensing a cushioning wrap material from a roll of expandable slit sheet material having an expandable slit sheet material in an unexpanded state, the apparatus comprising:
a frame having a supply support for supporting the roll of expandable slit sheet material for rotation about a central axis as the expandable slit sheet material is pulled from the roll of expandable slit sheet material;
a tensioning device including:
a friction member abutting the roll of expandable slit sheet material; and
at least one force spring secured to the frame and the friction member, the force spring being configured to bias the friction member toward the roll of expandable slit sheet material in a direction perpendicular to the central axis as the expandable slit sheet material is pulled away from the roll of expandable slit sheet material and the roll of expandable slit sheet material decreases in diameter;
wherein the tensioning device is operable to constantly and automatically apply a rotational resistance on the roll of expandable slit sheet material as the roll of expandable slit sheet material decreases in diameter, the rotational resistance causing the expandable slit sheet material to expand from the unexpanded state to an expanded state as the expandable slit sheet material is pulled from the roll of expandable slit sheet material to form the cushioning wrap material;
wherein the friction member extends across an entire length or more of the roll of expandable slit sheet material in a direction of the central axis.

2. The dunnage conversion apparatus according to claim 1, wherein the friction member extends across at least a partial length of the roll of expandable slit sheet material in a direction of the central axis.

3. (canceled)

4. The dunnage conversion apparatus according to claim 1, wherein the friction member has friction member supports pivotably mounted to the frame, and a bar member mounted to the friction member supports, the bar member extending parallel to and contacting the roll of expandable slit sheet material.

5. The dunnage conversion apparatus according to claim 1, wherein the at least one force spring is secured to the frame at a first end thereof and is secured to the friction member at a second end thereof.

6. The dunnage conversion apparatus according to claim 1, wherein the at least one force spring is a constant force spring.

7. The dunnage conversion apparatus according to claim 1, wherein the at least one force spring is configured to bias the friction member against the roll of expandable slit sheet material such that the bar member constantly abuts the roll of expandable slit sheet material as the roll of expandable slit sheet material decreases in diameter.

8. The dunnage conversion apparatus according to claim 1, further comprising a pair of powered gripping rollers configured to engage the expandable slit sheet material and pull the expandable slit sheet material from the roll of expandable slit sheet material.

9. The dunnage conversion apparatus according to claim 8, wherein the pair of powered gripping rollers are mounted downstream of the roll of expandable slit sheet material and the tensioning device.

10. The dunnage conversion apparatus according to claim 8, wherein the pair of powered gripping rollers are biased toward one another and are configured to receive the expandable slit sheet material therebetween.

11. The dunnage conversion apparatus according to claim 8, further comprising a cutting device for cutting the cushioning wrap material after a desired length of expandable slit sheet material has been pulled away from the roll of expandable slit sheet material and a desired length of cushioning wrap material has been formed.

12. The dunnage conversion apparatus according to claim 11, wherein the cutting device is mounted downstream of the roll of expandable slit sheet material, the tensioning device, and the pair of powered rollers.

13. A dunnage conversion apparatus for dispensing a cushioning wrap material from a roll of expandable slit sheet material having an expandable slit sheet material in an unexpanded state, the apparatus comprising:
a frame having a supply support for supporting the roll of expandable slit sheet material for rotation about a central axis as the expandable slit sheet material is pulled from the roll of expandable slit sheet material;
a plurality of pre-expansion rollers extending parallel to and spaced apart from the central axis, the plurality of pre-expansion rollers forming a serpentine path through which the expandable slit sheet material passes as the expandable slit sheet material is pulled away from the roll of expandable slit sheet material;
wherein the plurality of pre-expansion rollers cause the expandable slit sheet material to expand from the unexpanded state to a pre-expanded state as the expandable slit sheet material passes through the serpentine path, thereby reducing an amount of stretching force required to cause the expandable slit sheet material to expand to the expanded state to form the cushioning wrap material.

14. The dunnage conversion apparatus according to claim 13, wherein the plurality of pre-expansion rollers include three pre-expansion rollers forming the serpentine path.

15. The dunnage conversion apparatus according to claim 13, further comprising a pair of powered gripping rollers configured to engage the expandable slit sheet material and pull the expandable slit sheet material from the roll of expandable slit sheet material.

16. The dunnage conversion apparatus according to claim 15, wherein the pair of powered gripping rollers are mounted downstream of the roll of expandable slit sheet material and the plurality of pre-expansion rollers.

17. The dunnage conversion apparatus according to claim 15, wherein the pair of powered gripping rollers are biased toward one another and are configured to receive the expandable slit sheet material therebetween.

18. The dunnage conversion apparatus according to claim 13, further comprising a cutting device for cutting the cushioning wrap material after a desired length of expandable slit sheet material has been pulled away from the roll of expandable slit sheet material and a desired length of cushioning wrap material has been formed.

19. (canceled)

20. A method of dispensing a cushioning wrap material from a dunnage conversion apparatus having a roll of expandable slit sheet material rotatably supported by a frame of the dunnage conversion apparatus for rotation about a central axis, the roll of expandable slit sheet material including an expandable slit sheet material in an unexpanded state, the method comprising the steps of:
pulling the expandable slit sheet material away from the roll of expandable slit sheet material, wherein pulling the expandable slit sheet material away from the roll of expandable slit sheet material causes the roll of expandable slit sheet material to rotate about the central axis and decrease in diameter; and
constantly and automatically applying a rotational resistance on the roll of expandable slit sheet material with a tensioning device as the roll of expandable slit sheet material decreases in diameter to cause the expandable slit sheet material to expand in length and thickness during the pulling;
wherein the tensioning device includes a friction member abutting the roll of expandable slit sheet material, and at least one force spring secured to the frame and the friction member; and
wherein the step of constantly and automatically applying a rotational resistance on the roll of expandable slit sheet material includes biasing the friction member of the tensioning device toward the roll of expandable slit sheet material in a direction perpendicular to the central axis with the force spring during the step of pulling the expandable slit sheet material and as the roll of expandable slit sheet material decreases in diameter.

21. A method of dispensing a cushioning wrap material from a dunnage conversion apparatus having a roll of expandable slit sheet material rotatably supported by a frame of the dunnage conversion apparatus for rotation about a central axis, the roll of expandable slit sheet material including an expandable slit sheet material in an unexpanded state, the method comprising the steps of:
pulling the expandable slit sheet material away from the roll of expandable slit sheet material and between a plurality of pre-expansion rollers extending parallel to and spaced apart from the central axis, the plurality of pre-expansion rollers forming a serpentine path through which the expandable slit sheet material is pulled; and
expanding the expandable slit sheet material from the unexpanded state to a pre-expanded state as the expandable slit sheet material is pulled through the serpentine path formed by the plurality of pre-expansion rollers.

22. A dunnage conversion apparatus for dispensing a cushioning wrap material from a supply of expandable slit sheet material having an expandable slit sheet material in an unexpanded state, the apparatus comprising:
a supply support for the supply of expandable slit sheet material;
a tensioning device that facilitates application of constant tension to the expandable slit sheet material as the expandable slit sheet material is drawn from the supply, the constant tension causing the expandable slit sheet material to expand from the unexpanded state to an expanded state to form the cushioning wrap material.
